(19) United States
(12) Patent Application Publication
(10) Pub. No.: US 2008/0258495 A1
(43) Pub. Date: Oct. 23, 2008

(54) Motor Vehicle Door

(75) Inventor: Michael Fuetterer, Hildrizhausen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/632,413

(22) PCT Filed: Jun. 18, 2005
(86) PCT No.: PCT/EP2005/006607

§ 371 Date: May 2, 2008

(30) Foreign Application Priority Data
Jul. 15, 2004 (DE) 20 2004 015 344.0
Nov. 18, 2004 (DE) 10 2004 055 566.4
Mar. 1, 2005 (DE) 10 2005 009 183.0

(51) Int. Cl. B60J 5/00

(52) U.S. Cl. 296/146.5

(57) ABSTRACT

A motor vehicle door is provided which includes an inside door lining, a window plane and an outer door panel, wherein the motor vehicle door is separated, as seen from the outside to the inside, by a sealing surface into a wet region and a dry region. The sealing surface is realized by a molded foam part, which serves to reduce noise and to protect against moisture.

### CROSS REFERENCE TO RELATED APPLICATIONS

This application is a national stage of PCT International Application No. PCT/EP2005/006607, filed Jun. 18, 2005, which claims priority under 35 U.S.C. § 119 to German Patent Application Nos. 20 2004 015 344.0, filed Jul. 15, 2004, 10 2004 055 566.4, filed Nov. 18, 2004 and 10 2005 009 183.0, filed Mar. 1, 2005, the entire disclosures of which are herein expressly incorporated by reference.

### BACKGROUND AND SUMMARY OF THE INVENTION

The present invention relates to a motor vehicle door.

Motor vehicle doors in modern passenger vehicles frequently include different modules, such as an outer module, which has a frame, an outer panel and side impact protection strips, and an inner module, which serves essentially for the fastening of add-on parts and door linings.

German patent document DE 101 33 420 A1 describes a motor vehicle door which includes two such modules. In this case, the inner module has a plastic housing onto which an inside door lining is fitted by a coating process. Various units and elements, such as speakers, are also fastened to this plastic housing. Furthermore, an additional hybrid component constructed from plastic and metal is screwed onto this plastic housing. Taking a door assembly as the starting point, this hybrid component is positioned, as viewed from the outside to the inside, approximately centrally, within a window plane. In this case, the actual plastic housing onto which the hybrid component is screwed does not take on any supporting properties.

The rigidity of this inner module and of the entire vehicle door is capable of improvement. Furthermore, the cost for installation for the assembled inner module is comparatively high. Furthermore, the construction space in the door is not optimally used by the hybrid component which is situated in the center, and this, inter alia, also has a negative effect on the width of the interior space.

Furthermore, a motor vehicle door is to be protected against wetness which can penetrate into the passenger compartment from the outside. The protection against moisture can additionally perform a noise-reducing function, as described in German patent document DE 35 10 018 C2, in which a foam coating is applied to a plastic film, the film ensuring the protection against moisture. Such a film laminate can, however, only be produced using a plurality of complicated and expensive work steps.

An object of the invention is to improve the protection against moisture of a vehicle door with simultaneous noise reduction.

This and other objects and advantages are achieved by a motor vehicle door according to the present invention, which includes an inside door lining, a window plane and an outer panel. A sealing surface is provided which separates the motor vehicle door (as seen from the outside to the inside) into a wet region and into a dry region. The sealing surface is formed by a molded foam part.

A molded foam part can be produced cost-effectively, can be shaped in accordance with the desired geometry and, in this connection, can have intrinsic stability. The molded foam part prevents moisture from penetrating from the wet region into the dry region. In addition, sound waves which penetrate from the outside through the door are absorbed by the molded foam part.

The molded foam part can be configured in shape such that a part of the molded foam part that faces the wet region has closed pores, with the inner part of the molded foam part (i.e., the part or the side which faces the dry region), having open pores. The closed pores better prevent moisture from penetrating through, whereas the open pores on the side of the dry region are particularly readily suitable for absorbing sound waves. The sound waves dissipate in the open-pore region of the molded foam part.

The molded foam part may be used in a motor vehicle door is composed of an outer module and an inner module. In this case, the molded foam part is preferably arranged on the inner module. For example, in the case of a supporting inner module, the inner module can be equipped with various units and control elements which are generally sensitive to moisture. The molded foam part closes off the inner module, with the result that the dry region of the motor vehicle door is formed by the inner module and the molded foam part. The inner module with the molded foam part and the already preassembled units can then be fitted in a simple manner onto the outer module of the motor vehicle door. As a rule, no or only a few apertures are required through the molded foam part, which additionally improves sealing against moisture and noise reduction.

In an exemplary embodiment of the present invention, the inner module can have an inside door lining which is fitted onto a supporting surface of the inner module.

An inside door lining is understood here as meaning any type of coating, for example including leather, material or plastic coverings, which, if appropriate, are fitted on a foam mounted in between, and further add-on parts, for example handles or storage compartments. These inside door linings serve for the decorative configuration of the interior space and are fitted onto a supporting surface of the inner module by corresponding joining processes.

In this case, the inner module can have a supporting structure which includes a reinforcing frame, and is joined to a plastic base support so as to form a hybrid component. The latter component is configured in such a manner that it improves the rigidity of the inner module and therefore of the entire door, and at the same time forms the supporting surface of the inside door lining.

The reinforcing frame is frequently configured in the form of a metallic frame, made of metals, such as steel, aluminum or magnesium, which can be produced by a conventional forming technique and by casting techniques. However, it is also expedient to produce the reinforcing frame by means of an insert in the form of a fiber-reinforced plastic.

The supporting structure of the inner module is therefore configured by an integrated hybrid component. The absence of a supporting hybrid component in the center of the door therefore significantly improves the utilization of the construction space in the vehicle door, increases the rigidity and facilitates the installation of add-on parts, since add-on parts can be greatly integrated onto the hybrid component per se.

The supporting structure of the inner module can be configured in such a manner that it additionally includes a window ledge and/or a door base and also a rear door end side. The integration of these narrow sides of the motor vehicle door into the inner module makes it possible for the outer module to be of correspondingly narrower design, which in turn leads to the separating plane between inner and outer module being able to be shifted further in the direction of the outside of the vehicle, which in turn leads to an increase in the elbow room in the passenger compartment.

In this case, the rear door end side on the inner module can be configured in such a manner that a door lock is arranged on it. The arrangement of the door lock on the separately preassemblable, inner module furthermore improves the overall cost of installation of the motor vehicle door.

In an exemplary embodiment of the present invention, a door seal runs along a joining surface in which the outer and inner modules are joined together. This serves to better seal the joining surface and can also serve to cover screw points, which run along the joining surface, by the door seal at the same time, which affords visual advantages.

The supporting structure of the inner module, which is configured in the form of the abovementioned hybrid component, can be geometrically shaped in such a manner that installation spaces for corresponding add-on parts are formed in the desired manner on the inner module, for example, for units.

In this case, in an advantageous manner, the plastic base support, which forms part of the hybrid component, can have fasteners which are already integrated into the plastic base support by the production process. These fasteners likewise serve to fasten add-on parts in units.

In an exemplary embodiment of the present invention, a drive unit of a window lifter can be fitted in the outer module of the motor vehicle door, which leads to a better utilization of the existing construction space.

In this connection, it is expedient for the drive unit for the window lifter to be fitted between a window plane and an outside door panel. This region of the motor vehicle door otherwise remains unused.

It is furthermore expedient to arrange a front door end side on the outer module, which door end side is offset in a stepped manner in its cross section. The region of the door end side which is offset in a stepped manner, together with a front end region of the inner module, can delimit a hollow cross section. Thus, the rigidity of the motor vehicle door is further increased, in particular in the highly loaded front door region. This increase also occurs in when the hybrid component of the inner module is configured in the form of a metal or the metallic frame in the region of the delimitation of the hollow cross section and the hollow cross section is therefore delimited in an encircling manner by a metal.

The molded foam part can be fastened to the inner module in an advantageous manner by a releasable adhesive connection. This is advantageous in particular in the event of repair work to the motor vehicle door.

In addition to the adhesive connection or instead of the adhesive connection, the molded foam part can have an encircling bead which is clamped into an encircling groove on the inner module. In principle, sufficient sealing between the molded foam part, the inner and the outer modules can take place by an adhesive connection of this type.

This sealing between the three components, the inner module, outer module and molded foam part, can also be supplemented by a sealing bead which, in the assembled state of these three components, bears against the molded foam part and presses the latter intensively against the inner module.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a view of the outer motor vehicle door module, as seen from the inside to the outside,

FIG. 2 shows a view of the inner module with a view from the outside to the inside,

FIG. 3 shows the supporting structure of the hybrid component of the inner module with a graphical differentiation between reinforcing frame and plastic base support,

FIG. 4 shows a schematic illustration of a vehicle door, in which the position of the sections according to FIGS. 5 to 7 is shown,

FIG. 5 shows a section along the line 5 from FIG. 4,

FIG. 6 shows a section along the line 6 from FIG. 4,

FIG. 7 shows a section along the line 7 from FIG. 4, and

FIG. 8 shows a section along the line 8 from FIG. 4, with a sealing film.

### DETAILED DESCRIPTION OF THE DRAWINGS

In the text below, the use of the advantageous molded foam part is combined with a motor vehicle door of modular construction. The construction of the motor vehicle door is discussed initially to aid comprehension.

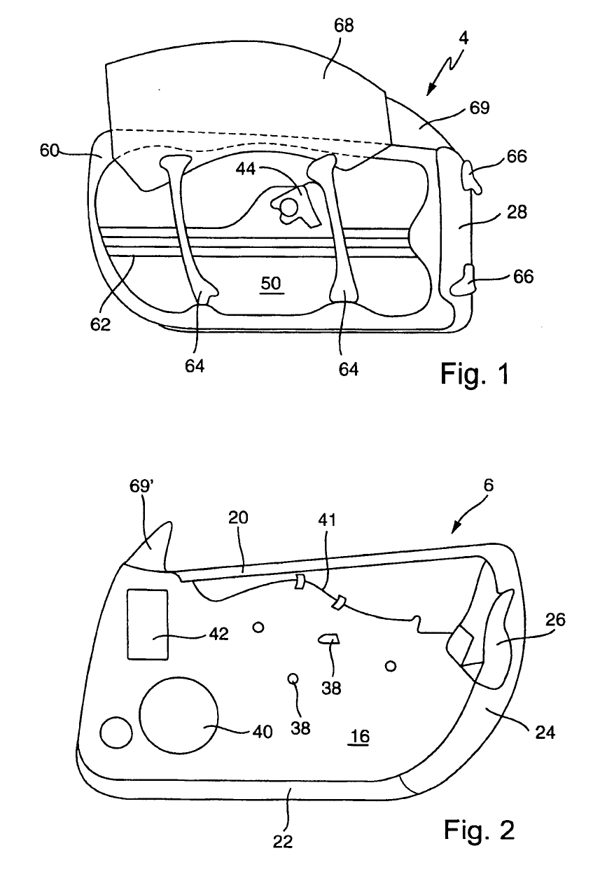

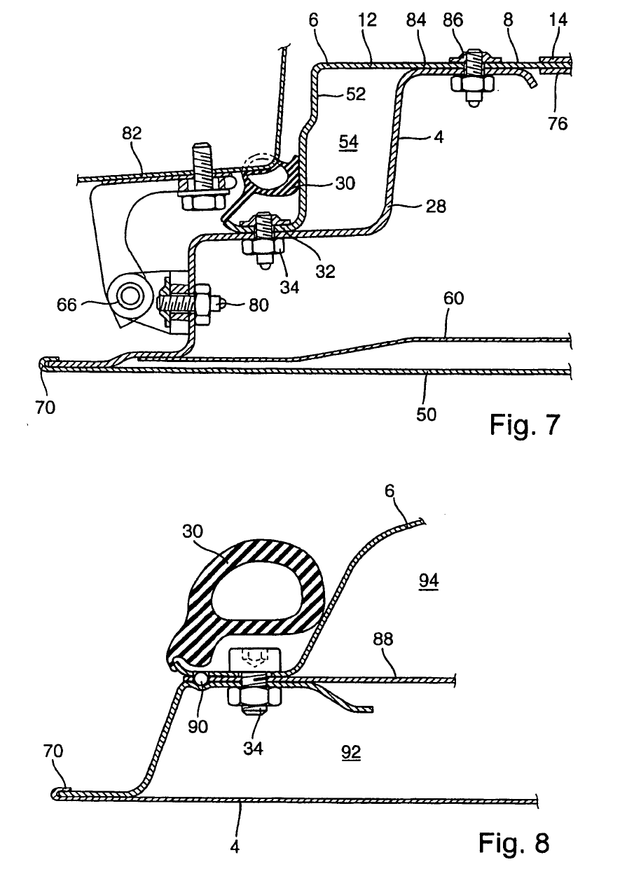

An illustration of an outer module 4 of a motor vehicle door 2 (cf. FIG. 4) is provided in FIG. 1. The outer module 4 includes a frame 60 to which an outside panel 50 is attached; furthermore, a side impact protection unit 62 runs from a front to a rear end of the module and ends in a front door end side 28. The front door end side 28 at the same time conceals hinges 66. The construction of the front door end side 28 is explained in more detail in the description of FIG. 7.

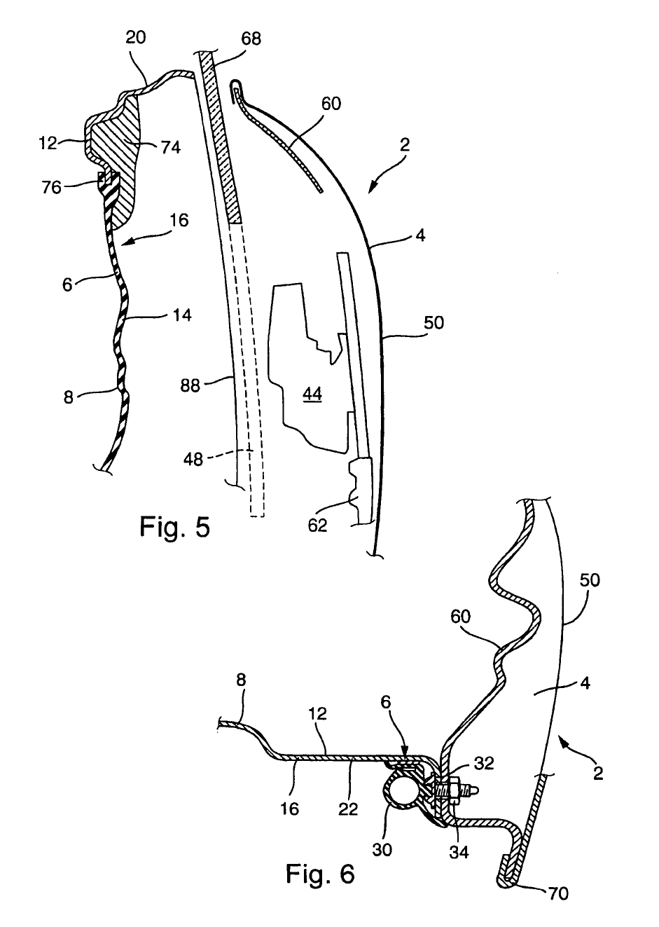

Furthermore, the outer module includes a window 68 and rails 64 of a window lifter and a drive unit 44 of a window lifter, which is mounted on a bulging portion of the side impact protection unit 62. As can be seen in FIG. 5, the drive unit 44 of the window lifter lies outside a window plane 48 (FIG. 5), which is advantageous for the construction space in an inner module 6.

In principle, the outer module can also include regions of the door base, the window ledge and the front and rear door end sides. However, there are efforts to largely integrate these narrow sides of the door in an inner module 6.

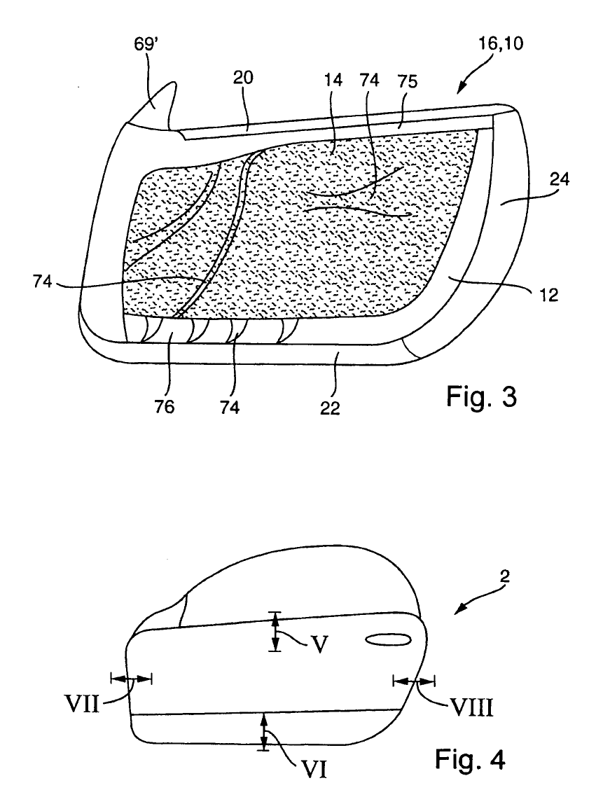

The inner module 6 of the motor vehicle door 2 is illustrated in FIG. 2, in which the view of the inner module 6 runs from the outside to the inside. The inner module 6 is based essentially on a supporting structure 10 is formed by a hybrid component 16, which is viewed separately and in detail in FIG. 3.

In addition to the hybrid component 16, the inner module 6 includes various add-on parts 40, for example, speakers or installation units 42, such as a door control device. Furthermore, fasteners 38 to which further add-on parts, for example, door handles, can be fastened are integrated in a plastic base support 14 (cf. FIG. 3). Furthermore, the inner module 6 includes supply lines 41, such as, for example, electric cables or Bowden cables, for actuating locks. A door lock 26 is likewise integrated in the inner module in the region of a rear door end side 24.

Furthermore, in this embodiment, the inner module includes a window ledge 20 which protrudes outward from the passenger compartment in the direction of the window 68, and a door base 22 which delimits the lower side of the door. The integration of these narrow sides, namely the window ledge 20, the door base 22 and the rear door end side 24, leads to the inner module 6 being of significantly thicker configuration in comparison to the outer module 4. This in turn affords the possibility of providing installation spaces for the add-on parts 40 and units 42 already discussed in the inner module. Furthermore, in this embodiment, the outer module 4 and the inner module 6 includes a respective triangular mirror 69 and 69′.

FIG. 3 illustrates the supporting structure 10, which is formed by the hybrid component 16, in more detail. The hybrid component 16 essentially includes a reinforcing frame 12, which is illustrated in white in FIG. 3 and is configured in the form of a metallic frame 12. The latter is referred to below as the metallic frame. Furthermore, the hybrid component includes a plastic base support 14, which is realized in dotted form in the illustration according to Figure 3. In this embodiment, the frame 12 includes a plurality of inserted sheet-metal structures which include the window ledge 20, the rear end side 24 and the door base 22. Next to these narrow sides, the metallic frame 12 is drawn into a side surface of the hybrid component 16, which contributes to further stiffening the hybrid component 16. The center of the side surface 75 is formed by the plastic base support 14.

In order to produce the hybrid component 16, frame elements which form the reinforcing frame, in particular, the metallic frame 12, are placed into a suitable injection mold, with free regions, which later form the plastic base body 14, being injected with a plastic compound. The frame elements are encapsulated by the plastic compound by injection molding and/or are injected through in regions of cutouts in the frame elements by the plastic compound, thus resulting in a fixed and stiff connection of the frame elements. If required, before being placed into the mold, the frame elements may also be joined to one another by welding or by a different joining method.

In this case, it is expedient to integrate plastic ribs 74 into the plastic base support 14 in order to further stiffen the hybrid component 16. During this injection molding process, the fasteners 38 which have already been described (cf. FIG. 2) can also be integrated at the same time. As a rule, regions 76 of the frame are also covered by the plastic base support, which can improve the connection between plastic base support 14 and metallic frame 12 and can serve as a means of coating the frame. This measure also enables fasteners 38 in the region of the frame 12 or above the metallic frame 12 to be configured from plastic. In addition to sheet-metal parts, the metallic frame 12 may also include cast parts, for example of aluminum, magnesium or else thin-walled cast steel. Furthermore, the use of fiber-reinforced plastics as frame elements is expedient. Frame elements of this type may be reinforced, for example, by glass fibers, aramide fibers or carbon fibers in the form of long fibers.

The metallic frame 12 is illustrated merely by way of example in its embodiment in FIG. 3. A plurality of different embodiments of the metallic frame is conceivable here. For example, sheet metal can run diagonally through the hybrid component 16. It is also not a prerequisite in all cases for the metallic frame 12 to surround the hybrid component 16 from the outside and along the narrow sides. However, the configuration of the narrow sides with the metallic frame provides an expedient and advantageous stiffening of the hybrid component 16.

On a passenger compartment side (not visible in FIG. 3), the entire hybrid component 16 has a supporting surface 8 (cf. FIG. 5) which can be provided for decorative reasons in the interior with a coating, for example by leather, materials or plastic linings. This supporting surface 8 of the hybrid component 16 is generally essentially formed by the plastic base support 14. This means in general that, on a passenger compartment side of the hybrid component 16, the frame 12 is amply covered by the plastic base support 14.

In FIG. 5, which illustrates a section along the line 5 from FIG. 4 in the region of the window ledge, the outer module 4 is depicted on the right side and the inner module 6 is depicted on the left side. A window 68 and a window plane 48 (illustrated by dashed lines) run between the two modules. It can be seen here that, contrary to a conventional construction of motor vehicle doors, an inside door panel, which is generally arranged between the window plane 48 and a support part for inside add-on parts, is omitted. In this construction, the reinforcing action of the customary inside door panel is formed by the hybrid component with its metallic frame 12 and the plastic base support 14.

The absence of this inside door panel means that the window plane is open on the outer module 4, as also illustrated in FIG. 1. The installation and setting of the window and of the window lifter components is thereby significantly facilitated.

Due to the substantial integration of the window ledge 20 and of the door base 22, which is not depicted in FIG. 5, and of the rear door end side 24 into the inner module 6 (which features are fitted to the outer module in the customary construction) and by the simultaneous saving of the inside door panel, the inner module 6 can be brought significantly closer to the window plane 48 and can be of correspondingly thinner configuration, which is of direct advantage for the elbow room in the passenger compartment. The absence of a hybrid component in the center of the motor vehicle door in front of the window plane, as is described in the prior art, also leads to the inner module 6 being able to be of correspondingly thinner configuration and to the elbow room being able to be increased.

In addition to the frame 60 of the outer module and the outside panel 50, the outer module 4 in FIG. 5 has a side impact protection unit 62 to which the drive unit 44 for the window lifter is fastened. In the case of vehicles with convex doors, this construction space can be used for accommodating the drive unit 44.

In the section through the inner module 6 in FIG. 5, in addition to the metallic frame 12, which includes the window ledge 20, the plastic base support 14 is also illustrated. The plastic base support 14 overlaps the metallic frame 12 in an overlapping region 76. In this illustration, the overlapping region 76 is configured to be very short; it may, as already indicated, also include the entire region of the metallic frame 12 on the interior side and therefore form the supporting surface 8 for the inside door lining. Furthermore, this sectional illustration schematically depicts a ribbed structure 74 which is integrated into the plastic base support 14 but runs beyond the latter into the frame 12 and therefore reinforces the frame 12 here in the region of the window ledge 20.

The section illustrated in FIG. 6 through the vehicle door 2 along the line 6 from FIG. 4 shows the cross section of the motor vehicle door 2 in the region of the door base. On the right side, the illustration shows the outer module 4, which includes the outside panel 50 and the frame of the outer module 60, the outside panel 50 being connected to the frame 60 in a fold 61 at the lower edge of the figure. Furthermore, the inner module 6 in the region of the door base 22 is depicted on the left side of FIG. 6. In this region, the door base 22 is mainly formed by the metallic frame 12 of the hybrid component 16.

The inner module 6 is screwed to the outer module 4 at an overlapping joining surface 32 by a plurality of screw points 34. The joining surface 32 with the screw points 34 is concealed by a door seal 30. This has visual advantages, namely that the joining surface cannot be seen, and contributes to the sealing of the joining surface 32. Other connecting methods, such as adhesive bonding or riveting, may likewise be expedient.

FIG. 7 depicts a section along the line 7 in FIG. 4 in the region of the front door end side. The section in FIG. 7 shows hinges 66 which are screwed to the outer module 4 by a screw connection 80. The outer module 4 has a front door end side 28 at this point. The front door end side 28 is the single narrow side of the door that is arranged in the outer module 4 in this embodiment.

The front door end side 28 has a stepped cross section; in particular, in this embodiment, the front door end side 28 is configured such that it has two steps. It is covered here by a front end region 52 of the inner module 4, this front end region 52 with the stepped arrangement of the front door end side 28 enclosing a cavity 54. The joining surface 32 (already described with regard to FIG. 6) with the screw point 34 and the seal 30 is arranged outside the hollow cross section 54. On the inside of the door, a further joining surface 84 with a further screw point 86 is likewise arranged outside the hollow cross section 54. In conjunction with the dual screw connections 86, 34 this doubling of the inner and outer modules, which forms the hollow cross section 54, further stiffens the entire motor vehicle door 2. In this case, that region of the inner module 6 which delimits the hollow cross section 54 is may be realized by the metallic frame 12 of the hybrid component 16 in order to further reinforce the stiffening effect of the hollow cross section 54.

FIG. 8 illustrates a section along the line 8 in FIG. 4, wherein here, in an advantageous refinement, a molded foam part 88 is arranged on the inner module 6 and therefore runs between the inner module 6 and the outer module 4. The molded foam part therefore separates the motor vehicle door 2 into a wet region 92, which is essentially surrounded by the outer module 4, from a dry region 94, which is essentially formed by the inner module 6. The molded foam part 88 may run behind the window plane 48, as seen from the outside, and therefore constitutes a sealing surface. The molded foam part may be configured to have closed pores on the wet space side or is provided with an additional film.

The molded foam part 88 is adhesively bonded to the inner module 6, for example, by a releasable adhesive connection. In this case, an adhesive connection (not illustrated in FIG. 8) runs continuously along a connecting line between molded foam part 88 and the inner module 6. The molded foam part covers (in a moisture proof manner), a partial cavity, which is formed by the inner module and is also referred to here as the dry region 94. In the event of a repair, the molded foam part 88 can be pulled off from the inner module without being destroyed and can subsequently be connected again to the inner module—if appropriate with the application of a new adhesive connection.

Furthermore, it may be expedient to fix an encircling bead to the molded foam part 88, the bead being pressed into an encircling groove (not illustrated here) of the inner module 4 and therefore ensuring a fixed, moisture proof fastening of the molded foam part 88 to the outer module 4. Of course, this encircling bead may be supplemented by an additional, releasable adhesive connection. The encircling groove on the inner module can be inserted in an advantageous manner into the plastic paneling 14 during production of the hybrid component 16.

In addition, a sealing bead 90 can be provided on the outer module, which may run along the joining surface 32 between the inner nodule 6 and the outer module 4. The sealing bead 90, additional sealing between wet region 92 and dry region 94 is obtained.

The sensitive components, such as cabling (supply lines 41), control devices (add-on parts 40 or units 42), plugs or the door lock 26 are essentially arranged in the dry region. It is cost-effective if these components do not have to be configured to be secure for a wet space, i.e. moisture resistant. Separate and expensive encapsulations of these components can be omitted.

The effect achieved by the described arrangement of the molded foam part 88 is that, in contrast to conventional door constructions, virtually all of the sensitive components are arranged in the dry region. This is to be attributed to the use of the supporting inner module 6 which bears the add-on parts 40, the supply lines 41 and units 42 and is fitted as an integrated component during the assembly of the motor vehicle door.

No additional apertures from the wet region to the dry region have to be provided (if appropriate, the cabling for the drive unit 44 of the window lifter is to be guided into the wet region). The low number of apertures also improves the acoustic shielding of the vehicle interior.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-22. (canceled)

23. A motor vehicle door comprising:
an inside door lining;
a window plane; and
an outer door panel; wherein,
a sealing surface separates the motor vehicle door, as viewed from outside to inside, into a wet region and a dry region; and
the sealing surface includes a molded foam part.

24. The motor vehicle door as claimed in claim 23, wherein the molded foam part is configured such that it has closed pores on a wet region side of the sealing surface.

25. The motor vehicle door as claimed in claim 23, wherein the molded foam part is configured such that it has open pores on a dry region side of the sealing surface.

26. The motor vehicle door as claimed in claim 23, wherein:
the motor vehicle door includes an outer module and an inner module; and
the molded foam part is arranged on the inner module.

27. The motor vehicle door as claimed in claim 26, wherein:
the inside door lining is fitted onto a supporting surface of the inner module;
the inner module has a supporting structure which comprises a reinforcing frame joined to a plastic base support to form a hybrid component; and
the hybrid component forms the supporting surface of the inside door lining.

28. The motor vehicle door as claimed in claim 27, wherein the supporting structure comprises a window ledge or a door base.

29. The motor vehicle door as claimed in claim 27, wherein the supporting structure comprises a rear door end side.

30. The motor vehicle door as claimed in claim 29, wherein a door lock is arranged on the rear door end side of the inner module.

31. The motor vehicle door as claimed in claim 27, wherein a door seal runs along a joining surface of the outer module and the inner module.

32. The motor vehicle door as claimed in claim 31, wherein the door seal conceals a screw point of the joining surface of the outer module and the inner module.

33. The motor vehicle door as claimed in claim 27, wherein the supporting structure of the inner module comprises installation spaces for add-on parts and units.

34. The motor vehicle door as claimed in claim 27, wherein the plastic base support of the hybrid component has fasteners for add-on parts and units.

35. The motor vehicle door as claimed in claim 27, wherein a drive unit for a window lifter is fitted to the outer module.

36. The motor vehicle door as claimed in claim 35, wherein the drive unit is fitted between a window plane and an outside door panel.

37. The motor vehicle door as claimed in claim 27, wherein the reinforcing frame is formed by a metal reinforcement.

38. The motor vehicle door as claimed in claim 27, wherein the reinforcing frame is formed by an insert of fiber-reinforced plastic.

39. The motor vehicle door as claimed in claim 26, wherein:
a front door end side is arranged on the outer module and is offset in a stepped manner; and
a region of the front door end side which is offset in a stepped manner, together with a front end region of the inner module, delimits a hollow cross section.

40. The motor vehicle door as claimed in claim 39, wherein the delimitation of the hollow cross section is formed by metal.

41. The motor vehicle door as claimed in claim 26, wherein the molded foam part is fastened to the inner module by a releasable adhesive connection.

42. The motor vehicle door as claimed in claim 26, wherein an encircling bead is fitted to the molded part and is clamped into an encircling groove on the inner module.

43. The motor vehicle door as claimed in claim 37, wherein a sealing bead is provided on the outer module, which, in the assembled state of the inner module and the outer module, bears against the molded foam part.

44. The motor vehicle as claimed in claim 26, wherein moisture-sensitive units are arranged in the dry region and are fastened to the inner module.
